(19) United States
(12) Patent Application Publication
(10) Pub. No.: US 2005/0088019 A1
(43) Pub. Date: Apr. 28, 2005

(54) Non-stop active car headrest

(76) Inventor: Wlodzimierz Myslowski, Bielsko-Biala (PL)

Correspondence Address: POWER DEL VALLE LLP, 233 WEST 72 STREET, NEW YORK, NY, 10023, US

(21) Appl. No.: 10/472,459

(22) PCT Filed: Feb. 25, 2002
(86) PCT No.: PCT/PL02/00015

(30) Foreign Application Priority Data
Mar. 21, 2001 (PL) P.346628

(51) Int. Cl. B60N 2/42

(52) U.S. Cl. 297/216.12

(57) ABSTRACT

The object of the invention is a non-stop-active car headrest, used as additional head support in seats, particularly in cars. A non-stop-active car headrest in the form of a closed container (2) consists of at least one layer (8), and preferably several elastic layers (8) and (9) filled with an elastic filling (10), and is provided with a negative pressure system nozzle (7) with a shut-off valve, while the container (2) is supported from the back with at least one elastic element (4), bent out in the direction of passenger's head.

The object of the invention is a non-stop-active car headrest, used as additional head support in seats, particularly in cars.

So far, headrest solutions, particularly in cars, have allowed for a stepless or gradual adjustment of head support inclination and for the adjustment of its mounting height in the car seat. Due to the connection with the car seat, the headrests adjust to the shape of car seats rather than to the shape of drivers' or passengers' heads, which allows for a gap between the head and the headrest positions, and provides only a pointwise or linear head support, which makes their use uncomfortable and does not prevent cervical backbone injuries in case of people whose cars have been run into from the back. Recently, Opel introduced intelligent headrests, based on complex inertial systems, and designed to protect the backbones of car travelers. The design of these headrests aims at allowing them to move quickly, irrespective of the direction of the collision, towards the front of the vehicle, along the car seat longitudinal axis, until a confident head support is achieved. The solutions known so far have only been useful in case of vehicle collisions.

The purpose of the invention is to devise a headrest design, which would force a constant driver's and passenger's head support with the largest possible contact area of head and neck with headrest, during full vehicle operation cycle, i.e. smooth driving, acceleration, braking, and in particular, when the vehicle is run into from the back.

Non-stop-active car headrest in the form of a closed container according to the invention is characterised in that the container consists of at least one layer, and preferably several elastic layers filled with an elastic filling, preferably elastic air-filled balls and/or elastic foam balls, and is provided with a nozzle with a shut-off valve, while the container is supported from the back with at least one elastic element, bent out in the direction of passenger's head. The elastic element is preferably in a form of a leaf spring or a rotating shock absorber. The container is preferably filled with granulated plastic in the form of EPS foam balls. The container is preferably ellipsoidal in shape.

The advantage of the solution according to the invention is that thanks to putting it forward, toward driver's or passenger's head, which movement is forced by the elastic element used, i.e. a spring or a rotary shock-absorber, causing the shape of head to be impressed and preserved, which provides better and more comfortable head support, and the balls inside the headrest allow air between head and headrest. This prevents head chafing during hot season and provides warm feeling during freezing season. Another advantage is that the headrest is constantly in contact with head and neck during regular driving, and particularly, if the car is run into from the back, it prevents cervical backbone injuries.

Thanks to the fact that the structure of the headrest can be adjusted with a negative pressure, the structure can be made loose enabling the passenger's head to impress its shape on the headrest. Such a shape can be then preserved and fixed.

The object of the invention is shown in a sample embodiment drawing, where

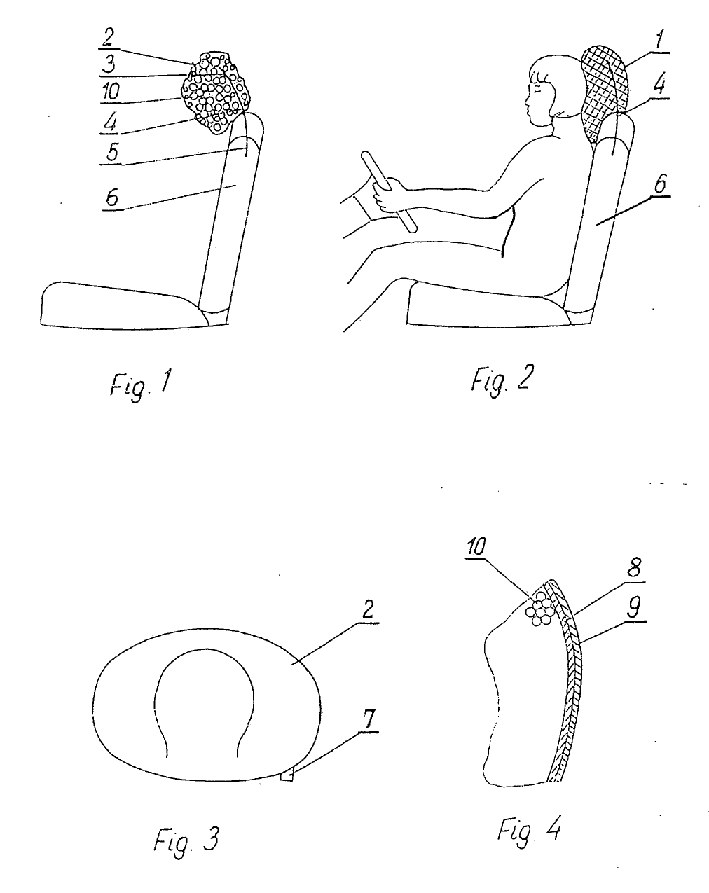

FIG. 1 shows the headrest diagrammatically in end view, in the rest position, when it is attached to an empty car seat;

FIG. 2 shows diagrammatically in end view the headrest attached to a car seat occupied by a passenger;

FIG. 3 shows the headrest in a front view with the head shape impressed; and

FIG. 4 shows a fragment of the headrest filled with plastic, air-filled balls.

As shown in the drawing, the headrest 1 is formed as a closed container 2, preferably ellipsoidal in shape with one end 3 of an elastic element 4, preferably in a form of a leaf spring or a rotating shock absorber, while the other end 5 is mounted in the car seat 6. The container 2 is provided with a negative pressure system 7. The container 2 consists of at least one layer 8, and preferably several elastic layers 8 and 9, and is filled with elastic filling 10 in the form of elastic, air-filled balls and/or elastic plastic balls. EPS foam balls may be used as the elastic filling.

After taking a seat in vehicle and resting head on the headrest 1, elastic elements 4 in the form of leaf spring or rotating shock absorber, hidden in the back part of the seat backrest 6, push the headrest 1 towards the head. This movement forces the headrest 1 to be pressed against the head, and then turns on the pump, which sucks the excess of air from the container 2 through the negative pressure system nozzle 7. On the headrest 1 and head contact area the shape of the head of the person sitting in the car seat 6 is impressed, and then a shut-off valve is closed. This procedure can be repeated many times for the same person or for different people, even without using the pump, just the pressure caused by the head of the person occupying a seat with a loose headrest 1.

1. Non-stop-active car headrest in the form of a closed container characterised in that the container (2) consists of at least one layer (8), and preferably several elastic layers (8) and (9) filled with an elastic filling (10), preferably elastic air-filled balls and/or elastic foam balls, and is provided with a negative pressure system nozzle (7) with a shut-off valve, while the container (2) is supported from the back with at least one elastic element (4), bent out in the direction of passenger's head.

2. The headrest according to claim 1, characterised in that the elastic element (4) is preferably in a form of a leaf spring.

3. The headrest according to claim 1, characterised in that the elastic element (4) is preferably in a form of a rotating shock absorber.

4. The headrest according to claim 1, characterised in that the container (2) is preferably filled with granulated plastic in the form of EPS foam balls.

5. The headrest according to claim 1 or 2, characterised in that the container (2) is preferably ellipsoidal in shape.
